(19) United States
(12) Patent Application Publication
(10) Pub. No.: US 2011/0111181 A1
(43) Pub. Date: May 12, 2011

(54) METHODS AND APPARATUS FOR BALANCING IMAGE BRIGHTNESS ACROSS A FLAT PANEL DISPLAY USING VARIABLE INK THICKNESS

(75) Inventor: Quanyuan Shang, Saratoga, CA (US)

(73) Assignee: APPLIED MATERIALS, INC., Santa Clara, CA (US)

(21) Appl. No.: 12/855,660

(22) Filed: Aug. 12, 2010

Related U.S. Application Data
(60) Provisional application No. 61/234,468, filed on Aug. 17, 2009.

(51) Int. Cl. B32B 3/26

(52) U.S. Cl. 428/173

(57) ABSTRACT

The present invention provides methods, apparatus and systems for balancing the brightness of a flat panel display using varying thicknesses of ink in a display object. The invention includes a display object for a flat panel display which includes a substrate, a pixel matrix on the substrate, and ink deposited into the pixel matrix. The ink deposited in a central area of the pixel matrix has a thickness that is greater than ink deposited in an edge/corner area of the pixel matrix. Numerous additional and alternative aspects of the invention are disclosed.

The present application claims priority to U.S. Provisional Patent Application Ser. No. 61/234,468, filed Aug. 17, 2009 and entitled “METHODS AND APPARATUS FOR BALANCING IMAGE BRIGHTNESS ACROSS A FLAT PANEL DISPLAY USING VARIABLE INK THICKNESS”, (Attorney Docket No. 13278/L), which is hereby incorporated herein by reference in its entirety for all purposes.

### FIELD OF THE INVENTION

The present invention relates to manufacturing flat panel displays using inkjet printing, and, more specifically methods and apparatus for balancing image brightness across a flat panel display using variable ink thickness.

### BACKGROUND OF THE INVENTION

Flat panel displays continue to increase in size with each new generation of technology. However, as the dimensions of the displays increase, difficulties with presenting accurate representations of images on larger displays may increase. Some of the problems associated with larger displays may be solved using manufacturing methods that compensate for such problems. What is needed therefore is improved methods of manufacturing flat panel displays.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

The present invention provides methods, apparatus and systems for balancing the brightness of a flat panel display using varying thicknesses of ink in a display object. The invention includes a display object for a flat panel display which includes a substrate, a pixel matrix on the substrate, and ink deposited into the pixel matrix. The ink deposited in a central area of the pixel matrix has a thickness that is greater than ink deposited in an edge/corner area of the pixel matrix. Other features and aspects of the present invention will become more fully apparent from the following detailed description, the appended claims and the accompanying drawings.

### BRIEF DESCRIPTION OF THE DRAWINGS

FIG. 1 is a block diagram depicting a side cross sectional schematic view of an example embodiment of an inkjet printing system in accordance with the present invention.

FIG. 2A is an illustration of a prior art display object.

FIG. 2B is a graph of ink thickness along line A-A across the prior art display object of FIG. 2A.

FIG. 2C is a graph of transmitted light along line A-A across the prior art display object of FIG. 2A.

FIG. 3A is an illustration of a display object according to embodiments of the present invention.

FIG. 3B is a graph of ink thickness along line A-A across the display object of FIG. 3A according to embodiments of the present invention.

FIG. 3C is a graph of transmitted light along line A-A across the display object of FIG. 3A according to embodiments of the present invention.

### DETAILED DESCRIPTION

As used herein, the term flat panel display (FPD) device is a generic term for all display devices having a relatively flat display surface, which includes such displays as, for example, liquid crystal displays (LCD), field emission displays (FED), vacuum fluorescent displays (VFD), organic light emitting diode displays (OLED) and plasma display panels (PDP). FPD devices may be formed from display objects, for example, such as color filters which include an array or matrix of pixel wells formed on a substrate which are each filled with ink. During manufacturing, a substrate may include a plurality of display objects which later may be separated and each used to make a different FPD device.

The amount of light transmitted through a pixel in a FPD device maybe a function of both the amount of light entering the pixel and the amount of light absorbed, reflected, or redirected as it passes through the pixel. The inventor of the present invention has determined that in many FPDs, less light typically passes through pixels near the edges and corners of the FPD (particularly when the light source is a point source or centrally located) and thus a “brightness” imbalance is created that detracts from the appearance and performance of the FPD. According to the present invention, this brightness imbalance may be compensated for by decreasing the amount of light absorbed, reflected, or redirected by the pixels along the edges and in the corners of the FPDs.

In addition to the position or location of the pixel, the amount of light absorbed, reflected, or redirected by a pixel may be a function of the thickness and the profile of the ink in the pixel. For example, a thicker layer of ink in a pixel may absorb more light than a thinner layer. Thus, according to embodiments of the present invention, by depositing less ink during the manufacturing process of the FPD in the pixels near the edges and corners, these pixels will absorb less light and the amount of light transmitted through the edge and corner pixels can be balanced with the more centrally located pixels. Alternatively or additionally, more ink may be deposited in the central pixels than in the pixels proximate the edges and corners.

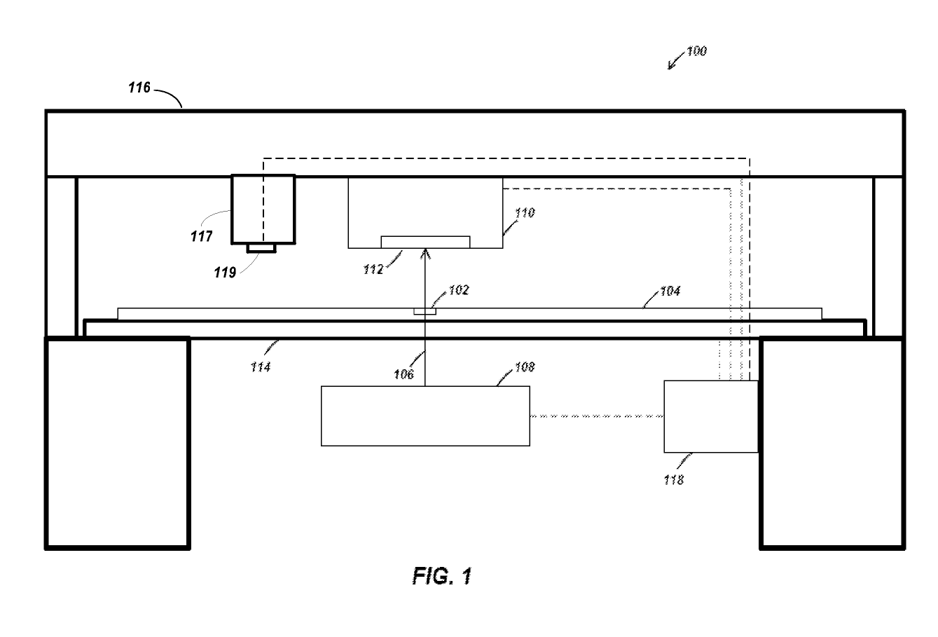

In addition, the amount of light transmitted through a pixel may be altered by differently shaped profiles of the ink in the pixel well. For example, a convex profile may cause less light to be absorbed into the black matrix side walls than a concave profile. As used herein, the term profile generally refers to the average cross-sectional shape along the top surface of the ink in a pixel. In other words, although the cross-sectional shape may vary depending on where the cross-section is taken, the term profile as used herein refers to the average of the shapes of several cross-sections taken at different points. These and other aspects of the invention are described below with reference to FIGS. 1 through 4.

FIG. 1 depicts a side cross section view of an example embodiment of an inkjet printing system 100 provided in accordance with the present invention. Such a printing system 100 may be used in the manufacture of color filter display objects for flat panel display devices. Specifically, the printing system 100 may be used to deposit ink 102 into pixel wells on a substrate 104. The printing system 100 may also be adapted to measure the deposited ink 102 on the substrate 104 using transmitted light 106. The transmitted light 106 may be transmitted from a light source 108 to a sensor (e.g., a camera 110) through the deposited ink 102 and the substrate 104. The camera 110 may have a CCD array 112 that receives the transmitted light 106. The camera 110 may convert the transmitted light 106 to signals (e.g., digital) that may be used to calculate the thickness of the deposited ink 102 by relating the amount of light transmitted to the thickness of the ink 102 on the substrate 104.

In some embodiments, the substrate 104 may be supported and moved on a stage 114 of the inkjet printing system 100. The stage 114 may include a window to allow light 106 from the light source 108 (e.g., disposed and supported below the stage 114) to reach the substrate 104 and the camera 110 which may be disposed above the stage 114. The camera 110 may be supported on a print bridge 116 of the inkjet printing system. The print bridge 116 may also support a plurality of moveable print carriages 117 (only one shown) that each include one or more print heads 119 (only one shown) for depositing ink 102.

In some embodiments, both the light source 108 and camera 110 may be disposed together above (or below) the stage 114 and a reflective surface may be employed to direct the light back through the substrate to the camera. By including a deposited ink measurement capability in an inkjet printing system 100, the ink may be deposited on the substrate 104, and then, without having to remove the substrate 104 from the inkjet printing system 100, an in situ measurement of the amount of ink deposited may be made. This saves time and allows more accurate measurement of the deposited ink which may include evaporating solvents and thus, have a changing volume.

The deposited ink 102 in the pixel matrix of the substrate 104 may be any suitable ink that is capable of being measured using transmitted light 106. The transmitted light 106 may be a white light (e.g., spectrum that appears as a white light to a person) although any suitable spectrum range may be employed. For example, it may be desirable to employ a particular frequency band that is more accurate with a particular CCD array or more suitable for a particular ink formulation or ink color. The transmitted light 106 may also be any suitable brightness. For example, it may be desirable that the transmitted light 106 is a white light that is about 10 to 1,000,000 cd bright although the light may be more or less bright. The transmitted light 106 may be provided by the light source 108.

The light source 108 may be a light emitting diode although any suitable light source may be employed. The light source 108 may be directional (e.g., laser, focused, collimated, etc.) although a non-directional (e.g., radiant) light source may be employed. The light source 108 may be homogenized, unified, diffused and/or integrated.

The camera 110 having the CCD array 112 may be a single or multiple pixel CCD camera though any suitable camera 110 and/or CCD array 112 may be employed. The camera 110 may include electronics that read data from the CCD array 112. For example, the camera 110 may have a data reader circuit that is adapted to select the rows and columns of the CCD array 112 to read data from a particular CCD sensor. The camera 110 may also include circuits and/or algorithms that filter, integrate, and/or prepare the data read from the CCD array 112 for interpretation.

In some embodiments, the camera 110 may also include a circuit that is adapted to communicate with other devices and/or computers. For example, the camera 110 may include a Universal Serial Bus (USB) circuit that converts the read/stored data to the USB communication protocol. Thus, another device and/or computer may read the data from the camera 110 for comparison with the other data and/or selected values.

In ink thickness measurement operation, the transmitted light 106 is transmitted through the deposited ink 102 from the light source 108 to the CCD array 112. The CCD array 112 receives the transmitted light 106 and converts the transmitted light 106 into a signal. For example, the CCD array 112 may convert the received transmitted light 106 into a binary representation of spectrum, intensity, brightness, power, level, amplitude, or any other suitable transmitted light parameter. Such signal may be stored and/or transmitted. For example, the signal may be stored in a memory circuit that is interstitial or interwoven with the CCD sensors. The memory circuit may have word lines (WL) and bit/read lines (RL) that reference a particular CCD pixel. Accordingly, the camera 110 or any other suitable sensor device may read the signal provided by the CCD array 112 at any particular CCD sensor. Groups of such CCD sensors may be selected to measure the deposited ink 102.

In some embodiments, the inkjet printing system 100 may further include a controller 118, wherein the controller 118 may be adapted to control movement of the print carriages 117 and stage 114 supporting the substrate 104 as well as movement and operation of the print heads 119, the camera 110 and the light source 108 (e.g., jetting of ink, sequencing of exposures, illumination of pixel wells, etc.).

In some embodiments the light sources may include one or more optical components adapted to help improve the consistency of the intensity and color of the light beam emitted by the light source and used to measure transmittance. Improved consistency allows more accurate measurement results. In some embodiments of the present invention, the optical component may include one or more color filters, which may correspond to the colors of the deposited ink to be measured. For example, a selected filter may be used to restrict the light from the light source to a desired range of wavelengths, thereby providing a light beam that may be more uniform in intensity and color. In some embodiments, a filter switching mechanism may be used to select different color filters. A different color filter may be selected based on a desired wavelength to be restricted and/or transmitted. In some embodiments, during a calibration procedure, the system may make a reference measurement for each of the filtered light colors and for a white light reference. The appropriate data may then be correlated with the corresponding measurement of the corresponding colored ink. In this manner, the amount of light transmitted through the pixel wells may be determined relative to the reference measurement.

In operation, the amount of ink deposited in a pixel well may be controlled by adjusting the number and size of ink drops deposited. In some embodiments of the present invention, the amount of ink to be deposited in a given pixel well may be determined based upon the pixel well's position relative to an edge (and/or corner) of the target display object. For example, pixel wells on the outer most columns and rows of a pixel matrix of a display object may only be filed to fifty percent of their full capacity. The next inner rows and columns may only be filled to sixty percent of their full capacity and the rows and columns three pixel wells from the edges may only be filled to seventy percent of their full capacity, etc.

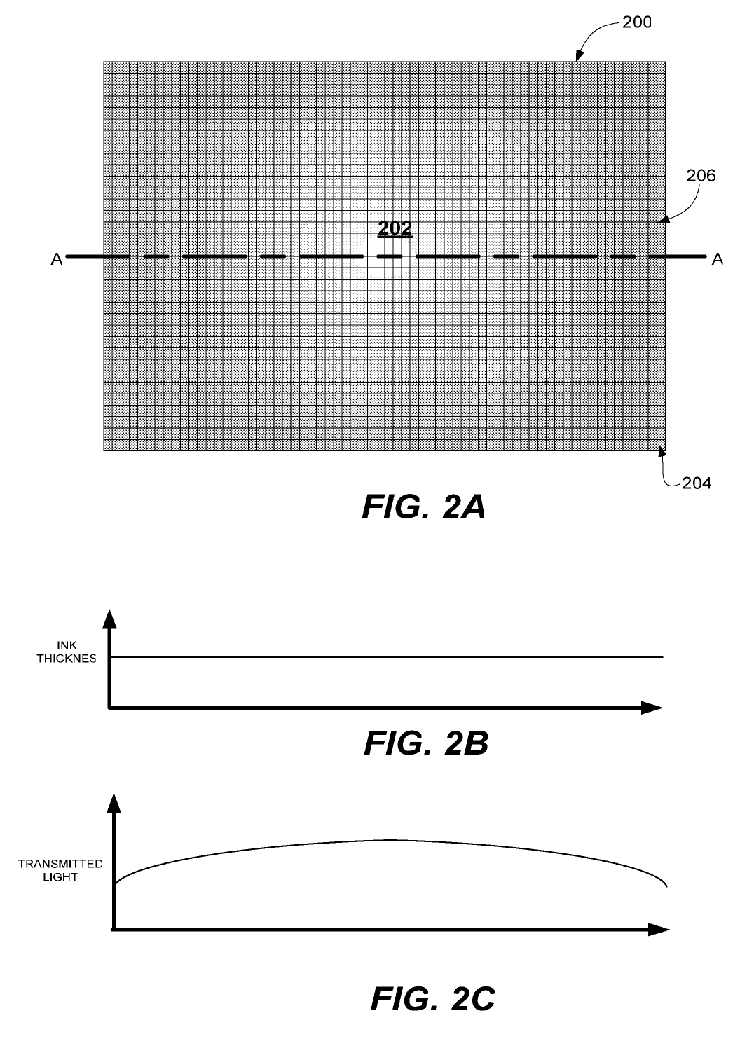

Turning to FIG. 2A, a prior art display object 200 is depicted. As shown, display object 200 includes a matrix of pixel wells that have been filled, each with approximately the same amount of ink. As indicated by the lighter area in the center pixel wells 202 and the darker areas in the corner pixel wells 204 and the edge pixel wells 206, the amount of light that passes through the display object 200 is not uniform across the uniformly filled display object 200.

Referring to FIGS. 2B and 2C, graphs of ink thickness and the amount of transmitted light respectively along the center line A-A of the display object 200 are provided which illustrate that same uneven display brightness problem. The graph in FIG. 2B indicates that the amount of ink deposited in the pixel wells along center line A-A is uniform. The graph in FIG. 2C indicates that the amount of light that passes through the pixel wells along center line A-A is greater in the central pixel wells 202 than at the edge pixel wells 206 of the display object 200.

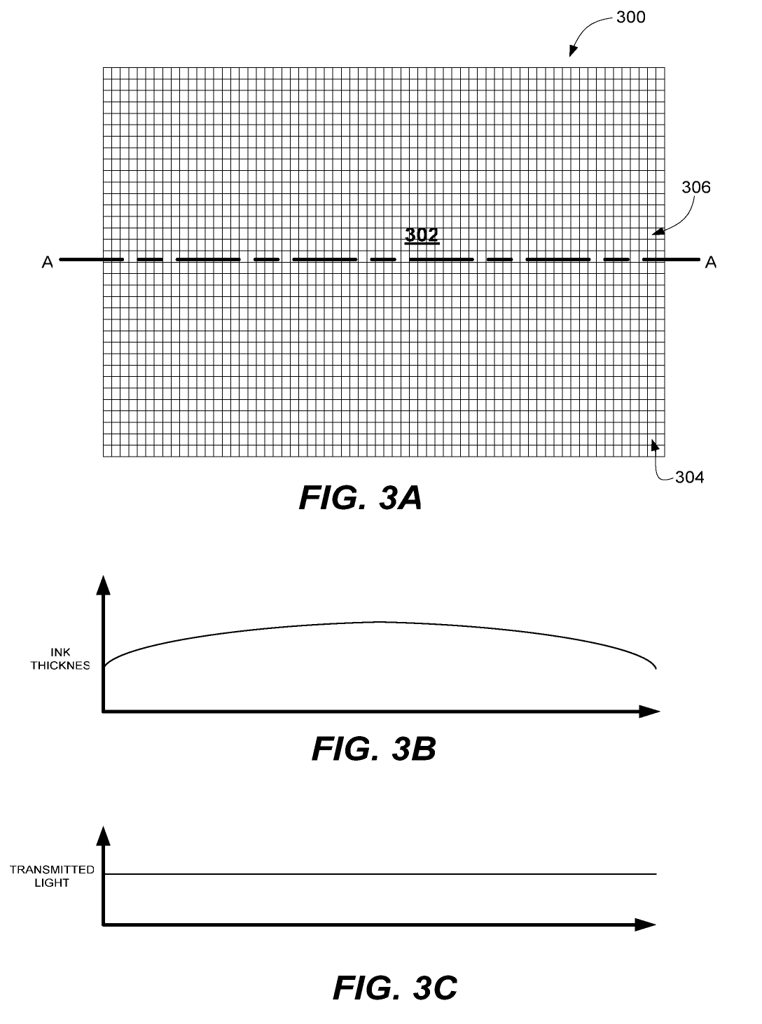

Turning now to FIG. 3A, a display object 300 manufactured according to the present invention is depicted. As shown, display object 300 includes a matrix of pixel wells that have been filled with varying amounts of ink based on the relative positions of the pixel wells in the display object 300. As indicated by the uniformity of the depicted display object 300 in the center pixel wells 302, the corner pixel wells 204, and the edge pixel wells 206, as compared to the prior art display object 200 depicted in FIG. 2A, the amount of light that passes through the display object 300 is uniform across the display object 300.

Referring to FIGS. 3B and 3C, graphs of ink thickness and the amount of transmitted light respectively along the center line A-A of the display object 300 are provided which illustrate that the prior art uneven brightness problem has been solved by the present invention. The graph in FIG. 3B indicates that the amount of ink deposited in the pixel wells along center line A-A varies across the display object 300. The graph in FIG. 3C indicates that the amount of light that passes through the central pixel wells 302 along center line A-A is balanced and uniform with the amount of light that passes through the edge pixel wells 306 along center line A-A of the display object 300.

In some embodiments, the present invention may include methods for determining the amount of ink to deposit in the different pixel wells 302, 306 of the display object 300. Using in situ measurement of the amount of light transmitted through various pixel wells from a light source that simulates the light source to be used to illuminate the display object in the FPD, the amount of ink per pixel well that results in a balanced display object brightness may be determined. More specifically, increasing amounts of ink may be deposited in central pixel wells between measurements until an optimized ink deposition or ink thickness layout for the display object may be determined.

The foregoing description discloses only exemplary embodiments of the invention. Modifications of the above disclosed apparatus and methods which fall within the scope of the invention will be readily apparent to those of ordinary skill in the art. For instance, in some embodiments, pixels on the edges and in the corners of an FPD may transmit more light than pixels in the center of the FPD and thus, more (or different) ink may be deposited in the edge and corner pixels than in the central pixels. Further, the present invention may also be applied to spacer formation, polarizer coating, and nanoparticle circuit forming.

Accordingly, while the present invention has been disclosed in connection with exemplary embodiments thereof, it should be understood that other embodiments may fall within the spirit and scope of the invention, as defined by the following claims.

The invention claimed is:

1. A display object for a flat panel display comprising:
a substrate;
a pixel matrix on the substrate;
ink deposited into the pixel matrix wherein the ink deposited in a first area of the pixel matrix has a first thickness that is different than a second thickness of ink deposited in a second area of the pixel matrix.

2. The display object of claim 1 wherein the first thickness is greater that the second thickness.

3. The display object of claim 1 wherein the first area is a central area of the pixel matrix.

4. The display object of claim 1 wherein the second area is an edge area of the pixel matrix.
